(19) United States
(12) Patent Application Publication
(10) Pub. No.: US 2026/0336319 A1
(43) Pub. Date: Oct. 29, 2026

(54) SECURITY ELEMENT, VALUE DOCUMENT, AND METHOD FOR PRODUCING SAME

(71) Applicant: GIESECKE+DEVRIENT CURRENCY TECHNOLOGY GMBH, Munchen (DE)

(72) Inventors: Manfred HEIM, Bad Tolz (DE); Winfried HOFFMULLER, Bad Tolz (DE); Christine HETTENKOFER, Egmating (DE); Andreas HOLZMEISTER, Dorfprozelten (DE); Erwin BACHER, Hausham (DE); Thomas MANG, Holzkirchen (DE)

(21) Appl. No.: 18/879,404

(22) PCT Filed: Jun. 19, 2023
(86) PCT No.: PCT/DE2023/100461

§ 371 Date: Dec. 27, 2024

(30) Foreign Application Priority Data
Jun. 29, 2022 (DE) 10 2022 002 353.9

(51) Int. Cl. B42D 25/47; B42D 25/29; B42D 25/324; B42D 25/328; B42D 25/355; B42D 25/373

(52) U.S. Cl. CPC B42D 25/47; B42D 25/29; B42D 25/324; B42D 25/328; B42D 25/355; B42D 25/373

(57) ABSTRACT

The invention relates to a security element for safeguarding a value document, comprising a carrier substrate, a coating provided with an optical surface mark, and a heat-sealable adhesive layer suitable for bonding the security element to a value document substrate, wherein the surface of the adhesive layer is provided with a coating which can be washed off on contact with washing liquid.

The invention relates to a security element for safeguarding a value document, comprising a carrier substrate, a coating provided with an optical surface mark, and a heat-sealable adhesive layer suitable for bonding the security element to a value document substrate. The invention further relates to a value document, more particularly a banknote, that is provided with the security element of the invention, and to a method for producing the value document.

Value documents, especially banknotes, are often safeguarded by being provided with security elements which allow the authenticity of the value document to be verified and which at the same time serve as protection against unauthorized reproduction. A particular part in the safeguarding of authenticity is played by security elements having viewing angle-dependent effects, since such effects cannot be reproduced even with the most modern of copying machines. These security elements are furnished with optically variable elements which convey a different image impression to the viewer at different viewing angles and for example, according to viewing angle, show a different color or lightness and/or a different graphical motif.

In value documents such as banknotes, for instance, it is known practice to introduce security elements in the form of security threads or to apply such elements in the form of security strips or security patches/security labels. Security elements typically have a heat-sealable adhesive layer serving to anchor the security element on the paper. When subjected to heat, the heat-sealable adhesive layer melts and acts as an adhesive.

EP 1 776 240 B1 describes a security element for safeguarding a value document, having a heat-sealable adhesive layer which is suitable for bonding the security element to a value document substrate and is substantially nontacky at room temperature, the adhesive layer being additionally UV-curing. In the course of the UV curing, there is an improvement in the adhesion of the security element on the value document substrate.

The security elements provided as part of the production of a value document typically take the form of a continuous foil. The heat-sealable adhesive layer with which the security elements are provided may in certain circumstances result in sticking-together of the security elements that are present in the wound continuous foil and that are stacked one atop another. The risk of elements sticking together exists in particular when there is a UV-curing, heat-sealable adhesive layer present.

It is therefore the object of the present invention to provide a security element of the kind mentioned at the outset that avoids the disadvantages of the prior art.

This object is achieved on the basis of the combinations of features defined in the independent claims.

Developments of the invention are subject matter of the dependent claims.

### SUMMARY OF THE INVENTION

1. (First aspect of the invention) Security element for safeguarding a value document, comprising a carrier substrate, a coating provided with an optical surface mark, and a heat-sealable adhesive layer suitable for bonding the security element to a value document substrate and more particularly being substantially nontacky at room temperature, characterized in that the surface of the adhesive layer is provided with a coating which can be washed off on contact with washing liquid.
2. (Preferred configuration) Security element according to clause 1, wherein the heat-sealable adhesive layer suitable for bonding the security element to a value document substrate and more particularly being substantially nontacky at room temperature is additionally UV-curing.
3. (Preferred configuration) Security element according to clause 1 or 2, wherein the coating provided with an optical surface mark exhibits an optically variable effect, more particularly a diffraction pattern, a hologram, a micromirror arrangement, a color flop effect, or a color change which varies when viewed in reflected light and when viewed in transmitted light.
4. (Preferred configuration) Security element according to any of clauses 1 to 3, wherein the coating provided with an optical surface mark comprises a metallization and an embossing varnish provided with an embossed relief, the metallization being more particularly a multi-ply thin-film element such as a multilayer reflector/dielectric/absorber arrangement or a multilayer arrangement comprising two semitransparent metallizations with a dielectric layer embedded between them.
5. (Preferred configuration) Security element according to any of clauses 1 to 4, wherein the security element is a security thread, a security strip or a security patch.
6. (Second aspect of the invention) Value document comprising a security element provided therewith and according to any of clauses 1 to 5.
7. (Preferred configuration) Value document according to clause 6, wherein the value document is a banknote.
8. (Third aspect of the invention) Method for producing the value document according to clause 6 or 7, comprising:
   the providing of a value document substrate;
   the providing of a security element, comprising a carrier substrate, a coating provided with an optical surface mark, and a heat-sealable adhesive layer suitable for bonding the security element to the value document substrate and more particularly being substantially nontacky at room temperature, the surface of the adhesive layer being provided with a coating which can be washed off on contact with washing liquid;
   the washing-off of the wash-removable coating by means of a washing liquid, to thereby liberate the adhesive layer;
   the providing of the value document substrate with the security element by means of the liberated adhesive layer at elevated pressure and elevated temperature.
9. (Preferred configuration) Method according to clause 8, wherein the adhesive layer is additionally UV-curing and the providing of the value document substrate with the security element additionally entails curing the adhesive layer by means of UV radiation.
10. (Preferred configuration) Method according to clause 8 or 9, wherein the security element is a security thread and the step of washing off the wash-removable coating by means of a washing liquid, to thereby liberate the adhesive layer, takes place before the embedding of the security thread into the value document substrate.

### COMPREHENSIVE DESCRIPTION OF THE PREFERRED EMBODIMENTS

The concept on which the present invention is founded is that of equipping a security element, for the safeguarding of a value document, with a heat-sealable adhesive layer which is suitable for bonding the security element to a value document substrate and which more particularly is substantially nontacky at room temperature, the surface of the adhesive layer being provided with a coating which can be washed off on contact with washing liquid. The coating which can be washed off on contact with washing liquid is preferably generated by printing using a printing ink. For the sake of simplicity, therefore, the coating which can be washed off on contact with washing liquid is referred to as “washable ink”.

Suitable coatings which can be washed off on contact with washing liquid are known in the prior art. EP 1 972 462 B1 describes a washable ink for producing a security element with a sharply contoured negative text. As soon as the washable ink comes into contact with a washing liquid, a gas is generated. Even minute amounts of gas lead to a sharp increase in pressure and hence to the exertion of a strong mechanical force, causing cracking in a metallization that is present above the washable ink. The apertures in the metallization that are obtained in this way and that have the design form in particular of characters, patterns or codes are perceived by the viewer as a sharply contoured negative text.

The founding concept of the present invention is based on the use of the prior-art washable ink as a cover for a heat-sealable adhesive layer. The security element that is to be generated, more particularly a security thread, security strip or security patch, is additionally equipped with washable ink at the point at which a heat-sealable adhesive layer is present. The washable ink is preferably applied by printing. The washable ink is washed off preferably by means of water as a suitable washing liquid. After the washable ink has been dissolved, the heat-sealable adhesive layer is present in free form and is able to bond unhindered to a value document substrate—a paper substrate, for example—that is to be safeguarded with the security element.

Suitable coatings which can be washed off on contact with washing liquid are described for example in EP 1 972 462 B1. The washable ink is based more particularly on a water-soluble binder, e.g., hydroxypropylcellulose, polyethylene glycol, casein and/or polyvinylpyrrolidone, with the optional admixing of one or more varieties of fillers, e.g., titanium dioxide, silicate and/or polymethylureas. Large amounts of fillers serve to provide the washable ink with porosity, which enables rapid ingress of the wash medium.

The security elements of the invention take the form typically of a continuous foil. The heat-sealable adhesive layer with which the security elements are provided is additionally equipped with washable ink, to thereby prevent sticking-together of the security elements that are present in the wound continuous foil and that are stacked one atop another. The risk of elements sticking together exists in particular when there is a UV-curing, heat-sealable adhesive layer present.

The security element of the invention for safeguarding a value document comprises a carrier substrate, preferably a polyethylene terephthalate (PET) foil, and a coating provided with an optical surface mark. The coating provided with an optical surface mark ensures a reproducibility which is difficult for the forger and so boosts the forgery-proof quality of the value document to be equipped with the security element of the invention. The coating provided with an optical surface mark preferably exhibits an optically variable effect, more particularly a diffraction pattern, a hologram, a micromirror arrangement, a color flop effect, or a color change which varies when viewed in reflected light and when viewed in transmitted light.

The coating provided with an optical surface mark preferably comprises a metallization and an embossing varnish provided with an embossed relief, the metallization being more particularly a multi-ply thin-film element such as a multilayer reflector/dielectric/absorber arrangement or a multilayer arrangement comprising two semitransparent metallizations with a dielectric layer embedded between them. The embossing varnish used may in particular be an embossing varnish which is crosslinkable by means of UV radiation. An example of a color-flopping multilayer reflector/dielectric/absorber arrangement would be a multilayer Al/SiO₂/Cr arrangement obtainable in particular by means of vapor deposition. A multilayer arrangement that exhibits a varying color change when viewed in reflected light and when viewed in transmitted light is known for example from WO 2011/082761 A1 and WO 2019/068362 A1 and is more particularly a multilayer arrangement comprising two semitransparent metallizations with a dielectric layer embedded between them, e.g., a multilayer Al/SiO₂/Al arrangement or a multilayer Ag/SiO₂/Ag arrangement.

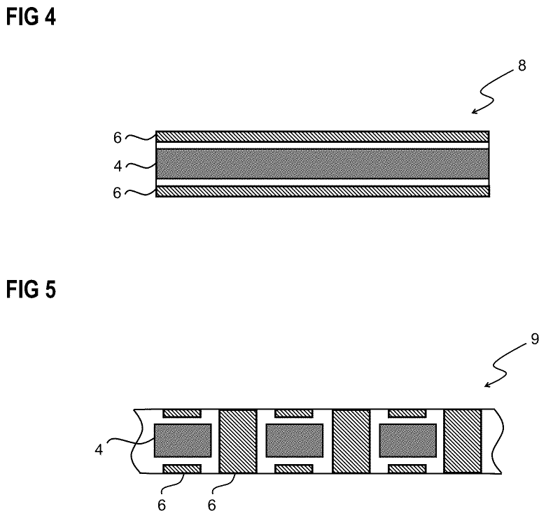

According to one preferred embodiment, the security element of the invention is such that both the heat-sealable adhesive layer which is suitable for bonding the security element to a value document substrate and more particularly is substantially nontacky at room temperature and the coating which is present above the adhesive layer and which can be washed off on contact with washing liquid are each present in structured form as a pattern, as characters or as a code. According to one specific variant here, the heat-sealable adhesive layer and the washable ink present above the adhesive layer are arranged outside the region of the coating provided with an optical surface mark. A structured heat-sealable adhesive layer is known in the prior art—see, for example, EP 1 880 864 A1. In accordance with the present invention, the structured arrangement of the heat-sealable adhesive layer and the washable ink may take place preferably in edge regions of the security element, in particular in register with the region of the coating provided with an optical surface mark. A structured arrangement of this kind would be advantageous in particular when the security element of the invention was present as a security thread. Especially in the case where the security element of the invention is present as what is called a windowed security thread, the heat-sealable adhesive layer and the washable ink are present in structured arrangement preferably in the regions to be provided with paper lands (when the security thread is embedded into a paper substrate), in particular in register with the regions of the coating provided with an optical surface mark (see, for example, FIG. 4a of EP 1 880 864 B1).

The heat-sealable adhesive layer which is suitable for bonding the security element to a value document substrate and more particularly is substantially nontacky at room temperature is preferably additionally UV-curing. As part of the application of the security element to a value document substrate to be safeguarded with the element, a paper substrate for example, there is an improvement, in the course of the UV crosslinking, in the adhesion of the security element on the value document substrate, with the internal strength of the cured adhesive layer rising to an advantageous degree. The temperature of the adhesive layer present immediately before, during and after the UV crosslinking is an important parameter determining the achievable degree of crosslinking. At higher temperature, a higher degree of crosslinking can be achieved, as the mobility of the reactive groups is higher. Suitable heat-sealable adhesive layers which are substantially nontacky at room temperature and are additionally UV-curing are known in the prior art see, for example, EP 1 776 240 B1.

The invention relates further to a value document which comprises a security element of the invention provided therewith, the value document being more particularly a banknote.

The invention relates further to a method for producing a value document, comprising:
the providing of a value document substrate;
the providing of a security element, comprising a carrier substrate, a coating provided with an optical surface mark, and a heat-sealable adhesive layer suitable for bonding the security element to the value document substrate and being more particularly substantially nontacky at room temperature, the surface of the adhesive layer being provided with a coating which can be washed off on contact with washing liquid;
the washing-off of the wash-removable coating by means of a washing liquid, to thereby liberate the adhesive layer;
the providing of the value document substrate with the security element by means of the liberated adhesive layer at elevated pressure and elevated temperature.

According to one preferred configuration, the adhesive layer is additionally UV-curing, wherein the providing of the value document substrate with the security element additionally entails curing the adhesive layer by means of UV radiation. The security element in this case is more particularly a security thread, wherein the step of washing off the wash-removable coating by means of a washing liquid to thereby liberate the adhesive layer takes place before the security thread is embedded into the value document substrate. For optimized wash-removing, it is possible optionally to employ spraying nozzles. The washing liquid is preferably water.

A suitable hot-stamp embossing press for implementing the method of the invention is known in the prior art. EP 3 173 232 B1, for example, describes a suitable hot-stamp embossing press with a foil applicator unit that is designed for transferring or laminating foil material by hot stamping to a substrate supplied in the form of consecutive sheets, the hot-stamp embossing press additionally comprising a UV curing unit.

Further advantages of the invention are set out below with reference to exemplary embodiments in conjunction with greatly schematically simplified figures, the depiction of which has been made without reproduction to scale and in proportion, in order to increase clarity.

In the drawings:

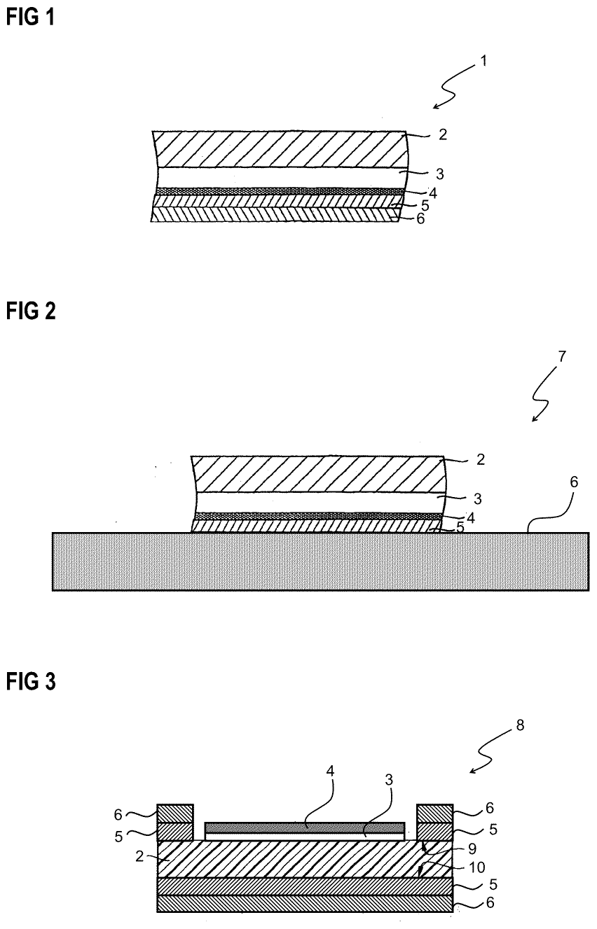

FIG. 1 shows a security element of the invention according to a first exemplary embodiment;

FIG. 2 shows a value document provided with the security element of the invention according to the first exemplary embodiment;

FIGS. 3 and 4 show a security element of the invention according to a second exemplary embodiment; and

FIG. 5 shows a security element of the invention according to a third exemplary embodiment.

FIG. 1 shows a view in cross section of a security element 1 of the invention, a security patch in the example, according to a first exemplary embodiment. A polyethylene terephthalate (PET) foil serves as substrate 2. The substrate 2 is provided with a UV embossing varnish 3, which has an embossed relief on the main face opposite the substrate 2. The embossed relief, for the sake of simplicity, is not shown in FIG. 1. The embossed relief may comprise, for example, microstructures and/or nanostructures, to generate diffractive optical effects, hologram effects or micromirror effects in combination with a reflective layer 4, e.g., a high-refractive-index layer or a metallization. In the case of a metallization, the arrangement in question may optionally be a thin-film element, e.g., a multilayer reflector/dielectric/absorber arrangement exhibiting a color flop effect. Examples of materials of high refractive index are CaS, CrO₂, ZnS, TiO₂, SiOₓ. The reflective layer 4 may also be applied in the form of patterns or characters, more particularly positive or negative patterns. Above the reflective layer 4, a UV dispersion is applied and dried thermally, at 80 °C, for example, to produce a heat-sealable adhesive layer 5 which is suitable for bonding the security element to a value document substrate, is substantially nontacky at room temperature, and is additionally UV-curing. The surface of the adhesive layer 5 is subsequently provided by printing with a coating 6 which can be washed off on contact with washing liquid.

Between the substrate 2 and the UV embossing varnish 3 there may optionally be a re-lease layer arranged, a wax layer for example, thus allowing the substrate 2 to be detached after the application of the security element 1 to a value document to be safeguarded with said element. Furthermore, between the reflective layer 4 and the adhesive layer 5, a primer layer and/or adhesion promoter layer may be arranged as and when required.

Since the heat-sealable adhesive layer 5 with which the security element 1 shown in FIG. 1 is provided is additionally equipped with washable ink 6, sticking-together of the security elements 1 present in a wound continuous foil and stacked atop one another is prevented. The risk of the elements sticking together exists in particular when a UV-curing, heat-sealable adhesive layer 4 is present.

The washing-off of the washable ink 6 is carried out preferably by means of water as a suitable washing liquid. After the washable ink 6 has dissolved, the heat-sealable adhesive layer 5 is present in free form and is able to bond unhindered to a value document substrate 6, a paper substrate for example, that is to be safeguarded with the security element (see FIG. 2).

FIG. 2 shows a value document 7, a banknote in the example, that is safeguarded with the security element 1 of the invention according to the first exemplary embodiment.

FIG. 3 shows a view in cross section of a security element 8 of the invention according to a second exemplary embodiment, a security thread in the example. The cross section shown in FIG. 3 has been made perpendicularly to the longitudinal direction of the security thread 8. The security thread 8 is based on a substrate 2, a polyethylene terephthalate (PET) foil in the example, having a top side 9 and a bottom side 10. At its top side 9, the substrate 2 is provided in the central region with a UV embossing varnish 3, which has an embossed relief on the main face opposite the substrate 2. For the sake of simplicity, the embossed relief is not shown in FIG. 3. The embossed relief may comprise, for example, microstructures and/or nanostructures, to generate diffractive optical effects, hologram effects or micromirror effects in combination with a reflective layer 4, e.g., a high-refractive-index layer or a metallization. At the top side 9 of the substrate 2, a UV dispersion is applied in each of the two edge regions and is dried thermally, at 80 °C, for example. This produces a heat-sealable adhesive layer 5 which is substantially nontacky at room temperature and which is suitable for bonding with paper lands when the security thread 8 is embedded in a banknote. The adhesive layer 5 in particular is additionally UV-curing. The surface of the adhesive layer 5 is subsequently provided by printing with a coating 6 which can be washed off on contact with washing liquid.

At the bottom side 10 of the substrate 2, a UV dispersion is applied over the full area and is dried thermally, at 80 °C, for example. This produces a heat-sealable adhesive layer 5 which is substantially nontacky at room temperature and which is suitable for reliable anchoring of the security thread 8 in the paper when the security thread 8 is embedded in a banknote. The adhesive layer 5 in particular is additionally UV-curing. The surface of the adhesive layer 5 is subsequently provided by printing with a coating 6 which can be washed off on contact with washing liquid.

FIG. 4 shows a plan view of the top side of the security thread 8 represented in FIG. 3.

FIG. 5 shows a security element 9 of the invention according to a third exemplary embodiment in a plan view of the top side of the security element. The third exemplary embodiment is based on the second exemplary embodiment according to FIGS. 3 and 4. As in FIG. 3, the layers 5 and 6 are arranged over the full area on the bottom side 10 of the substrate 2. On the top side 9 of the substrate 2, the layers 3 and 4 on the one hand and the layers 5 and 6 on the other hand, in the case of the windowed security thread 9, are arranged differently in spatial terms than in the case of the security thread 8. In the case of the windowed security thread 9 shown in FIG. 5, the heat-sealable adhesive layer 5 and the washable ink 6 are arranged in structured form in the regions to be provided with paper lands when the security thread 9 is embedded in a paper substrate, their arrangement in fact being in register with the regions of the coating provided with an optical surface mark (see the reference numerals 3 and 4).

1.-10. (canceled)

11. A security element for safeguarding a value document, comprising a carrier substrate, a coating provided with an optical surface mark, and a heat-sealable adhesive layer suitable for bonding the security element to a value document substrate,
wherein the surface of the adhesive layer is provided with a coating which can be washed off on contact with washing liquid.

12. The security element according to claim 11, wherein the heat-sealable adhesive layer suitable for bonding the security element to a value document substrate is additionally UV-curing.

13. The security element according to claim 11, wherein the coating provided with an optical surface mark exhibits an optically variable effect, more particularly a diffraction pattern, a holo-gram, a micromirror arrangement, a color flop effect, or a color change which varies when viewed in reflected light and when viewed in transmitted light.

14. The security element according to claim 11, wherein the coating provided with an optical surface mark comprises a metallization and an embossing varnish provided with an embossed relief, the metallization being more particularly a multiply thin-film element such as a multilayer reflector/dielectric/absorber arrangement or a multilayer arrangement comprising two semitransparent metallizations with a dielectric layer embedded between them.

15. The security element according to claim 11, wherein the security element is a security thread, a security strip or a security patch.

16. A value document comprising a security element provided therewith and according to claim 11.

17. The value document according to claim 16, wherein the value document is a banknote.

18. A method for producing the value document according to claim 16, comprising:
the providing of a value document substrate;
the providing of a security element, comprising a carrier substrate, a coating provided with an optical surface mark, and a heat-sealable adhesive layer suitable for bonding the security element to the value document substrate, the surface of the adhesive layer being provided with a coating which can be washed off on contact with washing liquid;
the washing-off of the wash-removable coating by means of a washing liquid, to thereby liberate the adhesive layer;
the providing of the value document substrate with the security element by means of the liberated adhesive layer at elevated pressure and elevated temperature.

19. The method according to claim 18, wherein the adhesive layer is additionally UV-curing and the providing of the value document substrate with the security element additionally entails curing the adhesive layer by means of UV radiation.

20. The method according to claim 18, wherein the security element is a security thread and the step of washing off the wash-removable coating by means of a washing liquid, to thereby liberate the adhesive layer, takes place before the embedding of the security thread into the value document substrate.
